(19) United States
(12) Patent Application Publication
(10) Pub. No.: US 2010/0109850 A1
(43) Pub. Date: May 6, 2010

(54) DUAL CONTROL SYSTEM AND METHOD

(75) Inventors: Joseph E. Kovach, Brighton, CO (US); James Baugh, Denver, CO (US); Paul F. Josephson, Longmont, CO (US); Michael S. Holford, Gilbert, AZ (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Inc., Upper Saddle River, NJ (US)

(21) Appl. No.: 12/438,320

(22) PCT Filed: Aug. 23, 2007
(86) PCT No.: PCT/US07/76646

§ 371 Date: Feb. 20, 2009

Related U.S. Application Data
(60) Provisional application No. 60/823,266, filed on Aug. 23, 2006.

(51) Int. Cl. H04Q 3/00; H04B 1/06

(52) U.S. Cl. 340/10.32; 455/230

(57) ABSTRACT

A controller for a device transmitting commands across one or more communication channels. Each such channel may employ a separate medium, such as radio waves and infrared light. The controller may transmit two separate signals to a device, where one signal is sent via radio waves and the other by infrared light. One signal may correspond to a group identifier and the other to an operating command to be carried out by the device. The device may receive both signals and, if the device belongs to a group corresponding to the group identifier, it may execute the operating command. Alternatively, the group identifier may be replaced by a wake command and the device may execute the operating command only if the wake command is received.

### CROSS REFERENCE TO RELATED APPLICATION

The present application is a Patent Cooperation Treaty patent application claiming priority under 35 U.S.C. §119(e) to U.S. provisional application No. 60/823,266 filed on Aug. 23, 2006 and entitled “Dual Media Control System and Method”, of which is hereby incorporated by reference herein in its entirety.

### THE INVENTIVE FIELD

The various embodiments of the present invention relate to wireless automation systems. More specifically, apparatus, processes, systems and methods for using a remote control device to control one or more battery powered and/or line powered devices is provided.

### BACKGROUND

Systems for controlling devices distributed throughout an office building, factory, home or other location have become desirable over the past several years. Such systems commonly utilize a remote control to directly control the operations and functions of one or more devices. The devices can be connected to and used to control one or more appliances (i.e., lights, shades, fire sensors, audio/visual equipment, security systems and others). Further, repeaters, amplifiers, centralized controllers and other components can be utilized in the system to create a network of devices that desirably can be controlled from any location, at any time, using a remote control device.

Remote control device commonly emit infra-red signals (“IR”) or radio frequency (“RF”) signals to send commands and/or other information to a device. However, many implementations for home/office automation systems require the placement of the devices in close proximity to each other. In some applications devices are configured to utilize the same IR and/or RF signals, thereby making control of an individual device difficult. Thus, a system and method is needed whereby any number of proximally located devices can be selectively controlled using a remote control.

### SUMMARY

Generally, certain embodiments described herein are directed to remotely controlling a device through commands transmitted across one or more communication channels. Each such channel may employ a separate medium, such as radio waves and infrared light. (The terms “radio frequency” and “infrared frequency” are used herein interchangeably with “radio waves” and “infrared light,” respectively.) Other embodiments described herein are directed to receiving dual media commands and executing them. For example, a remote control may transmit two separate signals to a device, where one signal is sent via a radio frequency and the other by an infrared frequency. One signal may correspond to a group identifier and the other to an operating command to be carried out by the device. The device may receive both signals and, if the device belongs to a group corresponding to the group identifier, it may execute the operating command. Alternatively, the group identifier may be replaced by a wake command and the device may execute the operating command only if the wake command is received.

By employing radio waves to carry a command, the command may be received by several devices within a relatively large or broad area and/or radius. By contrast, by employing infrared light to carry a command, the command may be received by only devices located within the narrow beam width of the infrared signal. Accordingly, in embodiments transmitting a first command via radio waves and a second command via infrared light, certain strategies for operating one or more devices capable of receiving the commands may be implemented. For example, the combination of a first command carried via radio waves and a second signal carried via infrared light may facilitate grouping of devices and/or operating grouped devices together. These and other strategies are more thoroughly discussed below.

In certain embodiments, a command may include multiple signals, each carried on or transmitted by means of different media. Alternatively, a single signal may contain an entire command. Further, in some embodiments a command carried by a signal may not be executed until another signal is initially received, processed, and/or executed. In other words, one command or signal may serve as a condition precedent to the execution or acknowledgement of a second command or signal.

One example of an embodiment of the present invention takes the form of a method for operating a device, including the operations of: receiving a first communications signal having a first characteristic; in response to the first communications signal, configuring a device into a first state; receiving a second communications signal having a second characteristic, the second characteristic different than the first characteristic; determining at least one command provided in the second communications signal; and executing the at least one command.

Another embodiment takes the form of an apparatus for remotely controlling a device, including: a first transmitter operative to transmit a first communications signal at a first frequency; a second transmitter operative to transmit a second communications signal at a second frequency; a processor operative to control the first and second transmitters; a group command module operative to transmit a grouping command to the device via one of the first and second transmitters, the group command module controlled by the processor; an operation command module operative to transmit an operation command to the device via one of the first and second transmitters, the operation command module controlled by the processor; and a wake command module operative to transmit a wake command to the device via one of the first and second transmitters, the wake command module controlled by the processor.

Yet another embodiment may take the form of a device operative to respond to a first and second remote signal, including: a processor; a first receiver operative to receive a first communications signal and convey first information associated with the first communications signal to the processor; a second receiver operative to receive a second communications signal and convey second information associated with the second communications signal to the processor; and application circuitry operative to control at least a portion of the device in response to a command from the processor, the command based at least partially on one of the first information and second information.

The operations and functionality of various embodiments described herein will be apparent to those of ordinary skill in the art upon reading this disclosure in its entirety, including the appended claims, and perusing the associated figures.

### DESCRIPTION OF THE FIGURES

FIG. 1 is an illustration of one embodiment of the use of dual media control of remote devices.

FIG. 2 is a block diagram illustrating one embodiment of a remote control for use in the various embodiments of the present invention.

FIG. 3 is a block diagram illustrating one embodiment of a device for use in the various embodiments of the present invention.

FIG. 4 is a flow diagram illustrating a process for use in selectively communicating data from a remote control to a device in accordance with at least one embodiment of the present invention.

FIG. 5 is a flow diagram illustrating a process for use in selectively communicating data from a remote control to a group of devices in accordance with at least one embodiment of the present invention.

FIG. 6 is a flow diagram illustrating a process for use in configuring a device to respond to one or more group settings in accordance with at least one embodiment of the present invention.

### DETAILED DESCRIPTION

The various embodiments of the present invention provide systems and methods for controlling any number of devices using a single remote control device that communicates data to and from such devices using both IR and RF signals. The various embodiments described herein can be configured to utilize various communications protocol such as those that minimize communication messages which may reduce the energy demands upon battery operated devices, as well as provide other capabilities. One example of such a communications protocol is described in U.S. Patent Application Ser. No. 60/662,959, entitled “System and Method for Adaptively Controlling a Network of Distributed Devices,” which was filed on Mar. 18, 2005. Other communications protocols can also be used with the various embodiments disclosed herein.

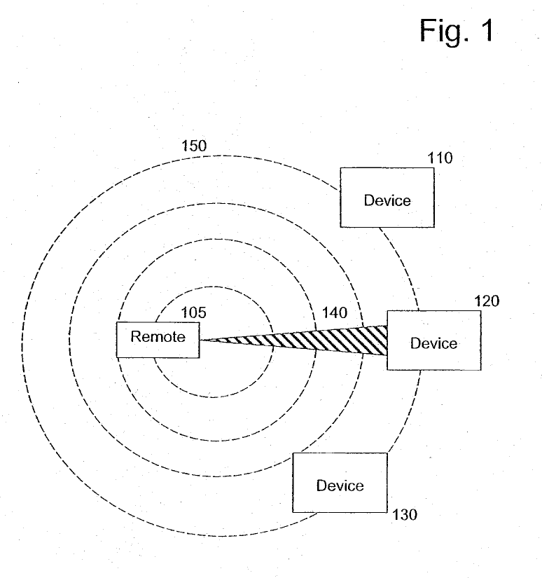

As shown in FIG. 1, for at least one embodiment, a system is provided wherein a remote control 105 is configured to transmit both IR signals and RF signals, simultaneously or separately, to one or more devices. The one or more devices, such as devices 110, 120 and 130, can be connected, directly or indirectly, to one or more appliances (not shown), such as new or existing coverings for an architectural opening (for example, POWERRISE window coverings manufactured by Hunter Douglas Inc.), audio/video equipment, industrial process equipment, security system components, or otherwise. The remote control 105 can be positioned at various locations relative to the devices 110/120/130 and can be stationary or mobile for any given period of time. Desirably, when in use, the remote control 105 is positioned such that a device is within the operating range of the remote control, wherein the operating range is determined and/or influenced by the output power, the signal characteristics, the ambient environment and other factors which influence, positively or negatively, the transmission, propagation and reception of a transmitted signal.

The devices 110/120/130 typically are configured to include both an IR receiver and an RF receiver and can be located at varying distances relative to each other and/or to the remote control. It should be noted that a single receiver capable or receiving both IR and RF signals (or other dual media) may be used in place of dual receivers. The devices 110/120/130 can also be stationary or mobile, as desired for any given implementation.

The remote control 105 transmits one or more IR signals 140 (as shown by the dashed lines). The IR signals 140 propagate from the remote control 105 and, desirably, towards the devices 110/120/130. The IR signals 140 can be configured to propagate at any desired degree or angle of beam dispersion, such as the circular dispersion pattern shown in FIG. 1. For example, a wide beam can be sent wherein the beam angle is approximately 60 degrees. Alternatively, a narrow beam, such as one with a dispersion angle of 15 degrees or less as shown in FIG. 1, can be sent. It is to be appreciated that by adjusting the beam dispersion angle, a desired beam pattern over a given area can be achieved. That is, an IR beam can be more narrowly focused, by lenses, apertures or otherwise, so that it can focus on an individual device rather than projecting on multiple devices over a large area. In one embodiment, a relatively narrow beam angle of approximately 10 degrees is utilized. Further, the IR beam can be configured so that “point and shoot” capabilities are provided whereby only those devices within a narrow beam angle emanating from the remote are contacted by the IR beam at any given time. It is to be appreciated that a narrow beam enables a user of the remote to individually control a select few (and often only one) apparatus at any given time.

In another embodiment, the remote control 105 transmits IR signals at one or more frequencies. For example, each of a plurality of devices can be configured to receive and respond to IR beams of a particular frequency or over a range of frequencies. The remote control 105 can be configured to transmit IR signals, intermittently or at the same time, at one or more desired frequencies and thereby communicate the data contained in the IR signal to multiple devices, tuned to different IR frequencies, at substantially the same time. In one embodiment, the remote control 105 is configured to transmit IR signals on two different channels. These emissions can occur independently, substantially simultaneously or simultaneously—as desired for a specific implementation or use of the remote control 105.

The remote control 105 can also be configured to transmit RF signals 150 at any single or multiple desired frequencies. The RF signals can be transmitted in any of various formats such as broadcast, multicast, narrowcast, point-to-multipoint, point-to-point, unicast, or otherwise. The RF signals can also be multiplexed onto a carrier so that multiple information signals are separately, or otherwise, transmitted to one or more devices.

The various embodiments of the remote control can be configured to include one or more grouping capabilities. For example, multiple individual RF groupings can be provided, whereby each group can be programmed (on the remote control) to emit RF signals specific to that group. Correspondingly, the devices associated with the one or more groups, can be programmed to receive and recognize RF signals associated with the given group(s). One of the groups can include an “all” functionality, whereby all of the groups programmed into a remote are activated at once. It is to be appreciated that the selection of one or more groups, on the remote control, can be accomplished by using one or more buttons (wherein each button is associated with at least one given group), using a push and hold technique (wherein the length of time a single button is held indicates which group is selected), and the like.

The remote control can also be configured so that it combines the features and capabilities of RF and IR signals in a single unit. More specifically, in at least one embodiment, the remote (and corresponding devices) can be configured so that both IR and RF signals are transmitted to the devices. For one exemplary embodiment, the remote control is configured to emit, upon the pressing of a button on the remote by a user, a signal that includes an RF component and an IR component. Specifically, upon the pressing of a button on the remote, the remote emits an RF signal for a given period of time. The corresponding devices receive the RF signal and exit a “sleep” mode (wherein the IR and RF receivers are cycled on and off, for given periods of time, in order to save power). After a predetermined time period has elapsed or substantially simultaneously, the remote sends an IR signal (which may have a narrow beam width). Those devices that are within the range (and beam pattern) of the RF signal and also within the range (and beam pattern) of the IR signal receive the signal and take appropriate actions (if any), according to the signal received and the programming/operation of the devices. Thus, at least one embodiment provides a remote control and corresponding device(s) which combine the salient feature of IR signals, namely their ease of use and “point and shoot” capabilities, with the salient features of RF signals such as the ability to communicate broadcast signals and awaken devices that would otherwise need to continually and/or periodically expend energy searching for and processing IR signals—some of which can be generated by devices other than remote 105 and which are not intended for use in control of the devices 110/120/130.

Further, the various embodiments can be configured to utilize a remote control device that utilizes RF signals programmed to control more than one device at a time. That is, an embodiment of the remote can include any number of group buttons (in one embodiment four group buttons and an “all” button can be provided). When a group button is depressed, the remote transmits an RF signal containing commands specific to a given group. Upon receipt of the RF signal, devices determine whether they have been previously programmed to respond to the given group command signals and, if so programmed, perform the given action, such as raising vanes, lowering vanes, opening vanes, closing vanes, tilting vanes or otherwise controlling the operation of a covering for an architectural opening, such as an awning or window shade. Grouping, including an example thereof, is discussed in more detail below. Commands, whether to wake, sleep, execute and operation, or add or remove a device from a group, may be encoded in the signal (either RF or IR) in any means known to those skilled in the art.

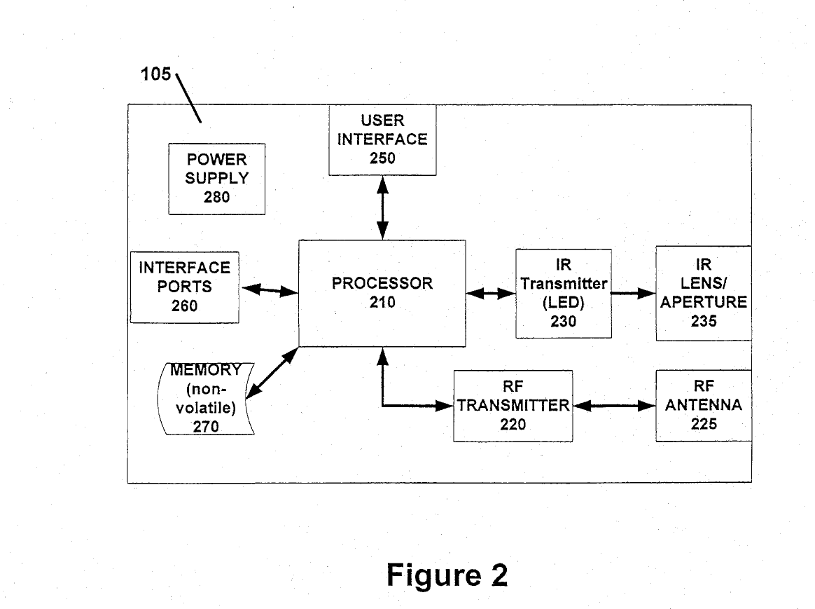

Referring now to FIG. 2 and another embodiment, the remote control 105 can be configured to include the following components: a processor 210; an RF transmitter 220 connected to RF antenna 225; an IR transmitter 230 connected to IR lens or aperture 235; a user interface 250 (which can include in various embodiments, for example, separate LEDs to indicate the emitting of an RF signal or an IR signal; separate buttons for selecting program modes, a separate programming button to initiate the programming of one or more devices, master resets and the like); one or more optional interface ports 260; a data storage and/or memory device 270; and a power source 280 (for example, one or more batteries). More specifically, for one embodiment, the processor 210 is a PIC16F913, manufactured by Microchip. The RF transmitter 220 may be, for example, a NRF24L01 transceiver, manufactured by NordIC and is configured to operate at an approximate frequency of 2.4 GHz and an output power of up to 4 dbm. In alternative embodiments, the RF transmitter 220 may operate at a lower frequency, thus transmitting data at a slower speed. This may be useful, for example, when transmission speed is less important than power consumption. Further, by employing a lower frequency transmitter, transmission in other bands or frequencies than RF may be used. In addition, the remote control 105 may include an amplifier (not shown) to increase the power of the RF signal.

The IR transmitter is an LED, such as MIE544A2 manufactured by Uni, emitting infrared signals at an output power of 10 mW and at a carrier frequency of 40 kHz. For at least one embodiment, RF transmitter and IR emitter are connected to one or more antennas, lens, apertures, wave guides or the like, as represented in FIG. 2 by antenna 225 and lens/aperture 235 (collectively, “antennas”). The remote control 105 can also be configured such that it operates over any given range. For example, the remote control can be configured to transmit a focused IR signal over a first distance, such as 30 feet, while transmitting an RF signal over a second distance, such as 200 feet. The exact distance over which the IR and/or RF signals are transmitted may vary in other embodiments. Conceivably, certain embodiments may be configures to transmit the IR signal further than the RF signal. Accordingly, the ranges set forth herein are meant by way of example rather than limitation.

The remote control 105 commonly is configured to include a user interface 250. The user interface 250 can include one or more user output components, such as one or more light emitting diodes (LEDs), a liquid crystal display and/or the like, that can be used to provide the user with information concerning the operation and/or status of the remote control 105. The remote control 105 commonly is also configured to include one or more user input components such as buttons, thumb scroll wheels, touch screens, microphones, and others input components commonly known in the art. In one embodiment, the remote control includes a channel selection switch, four group buttons, an “all” button, a master reset button and a program mode button. Other buttons and/or other user interface components can be provided in other embodiments of the remote control.

The remote control 105 can be configured to include one or more interface ports 260. The interface ports, can be utilized to connect the remote control 105 to one or more computer or telecommunications devices. Examples of interface ports include those compatible with standards such as those for universal serial bus, fire wire (i.e., IEEE 1394), SCSI, RS-232, RJ-11, RJ-45, RS-485, CAN bus, and others.

The remote control 105 can be configured to include a non-volatile memory 270 or data storage device (hereafter, “storage device”). Volatile memory can also be included with or separate from the processor 210. Examples of suitable storage devices that can be used with the various embodiments of the remote control 105 include, but are not limited to: flash memory; electrically erasable programmable read only memory (EEPROM); magnetic memory devices (e.g., magnetic tape and magnetic drums); optical memory devices (e.g., compact discs); and non-volatile random access memory (NVRAM). The storage device 270 can be configured to store one or more routines for configuring devices, such as by scene or setting, addresses for devices, and other information used by the processor 210 or to be communicated to a user. Such routines may include commands to wake, sleep, group and/or operate one or more devices; corresponding commands may be transmitted to devices via either the IR transmitter 230 or RF transmitter 220. The routines may take the form of one or more software elements or modules accessed by the processor. Alternatively, such modules may be electronically or directly controlled and under the control of the processor 210. A user may instruct the processor 210 to access and/or execute one or more modules via the user interface 250.

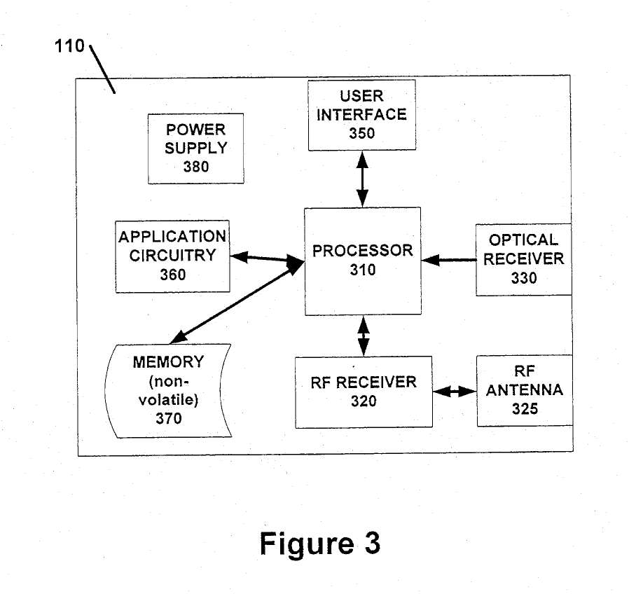

Referring now to FIG. 3, a schematic representation of a device 110 is shown for an embodiment. The device can be configured to include: a processor 310; an RF receiver 320 and antenna 325; an optical receiver 330; an optional user interface 350; application circuitry 360; memory 370; a power supply 380 and/or other components. The device 110 may also include a band pass filter to filter out signals received outside the transmission band of the remote control's 105 RF transmitter, thereby preventing interference or inaccurate control of the device 110. The device 110 may also include an analog-to-digital converter to convert the transmitted RF signal to a digital format for compatibility with operation of the processor 310. Neither the filter nor the converter are shown in FIG. 3 for purposes of clarity.

More specifically, the device can be configured to include a processor 310 such as a PIC16F913 or PIC16F916, both manufactured by Microchip. In one embodiment, the RF receiver 320 is a NRF24L01 transceiver, manufactured by NordIC and is configured to operate over a frequency range of approximately 2.40 to 2.48 GHz. The optical receiver 330 can be configured to receive optical signals, such as those emitted by the remote control 105, and in one embodiment is an TSOP348 series receiver manufactured by Vishay. This integrated infrared receiver is tuned to receive IR signals in the range of 30-56 kHz. This infrared receiver has built in amplification and filtering. In other embodiments a discrete optical receiver, amplifier, and filter may be used.

The device also can be configured to include an optional user interface 350. In certain embodiments, a user interface 350 can be provided which enables a user to operate the device directly by, for example, depressing or selecting one or more buttons. Further, the user interface 350 can be configured to include one or status indicators, such as LEDs, audible indicators, or the like.

Application circuitry 360 can also be included in the device 110. For example, various registers, relays, switches, input/output ports or the like can be configured to communicate with the processor 310. The application circuitry 360 can also be configured to include interfaces for one or more sensors. Such sensors can be included in an appliance, such as a position sensor for a window covering, or they can be provided separately, such as a motion sensor for a security system. Additionally, it is to be appreciated that the device 110 can be included within or separate from an appliance. Also, a device 110 can be configured to interface (and/or control) one or more appliances, one or more devices, one or more networks, combinations of the foregoing, or the like. Thus, the application circuitry 360 desirably provides those interfaces necessary to enable the device 110 to interact with a given appliance, device, network, system or the like. As one example, the application circuitry 360 may control the opening and/or closing of a covering for an architectural opening.

Memory or non-volatile storage can also be provided with the device 110. Any of the foregoing examples of memory/non-volatile storage can be used. Additionally, networked or remote storage can be used in the various embodiments discussed herein.

A power supply 380 is included with the device 110. The power supply can condition, as necessary, power provided by line, low voltage battery or otherwise and combinations thereof). The type of power supply used can vary from device to device, system to system and in accordance with any desired embodiment. For example, some devices in a system implementing certain embodiments can be line powered, while other devices are battery powered. Similarly, devices can powered by solar, wind or otherwise. In at least one embodiment, the device is configured to utilize a maximum of 100 microAmps on average. As discussed below, such low power usage can be accomplished by configuring the device to function predominantly in a “sleep” mode, wherein the optical receiver, amplifier, and related components are inactive except when activated upon the receipt, by the device, of an RF signal.

As one example of the foregoing sleep mode, the device may occupy a powered-down or minimally-powered state as a default. In such a powered-down state, the device may not receive or acknowledge either RF or IR signals, or both, generated by the remote control 105. At certain time intervals (for example, every 250 milliseconds), the device may power up in such a manner as to receive, acknowledge, and/or operate in response to an RF and/or IR signal (referred to herein as “waking”). The powered-up state may last for a set interval if no such signal is received. As yet another example, the powered-up state may last for 2.5 milliseconds, or 1/100^{th} the duration of the powered-down state. If an RF and/or IR signal is detected by the device during the powered-up state, the device may wake and operate in the powered-up mode until a set time elapses during which no signal is received, after which the sleep cycle is initiated. In some embodiments, a wake command must be received before the device wakes. In alternative embodiments, receipt of any valid and recognized command may wake the device, rendering the implementation and use of a unique wake command unnecessary.

As one example of the foregoing, an embodiment of a device may wake only the RF receiver at intervals during the sleep cycle. When the RF detector receives a signal, the IR detector may be powered up. Further, in some embodiments, the RF signal may be broadcast at two or more different bands or frequencies. These bands may vary slightly or significantly from one another. The device, via the RF detector (whether or not integrated with the IR detector), may detect either RF transmission band. By employing two different transmission bands, the possibility of interference preventing the IR receiver from waking may be reduced. It should be noted that, in embodiments with a leading IR transmission waking a sleeping RF detector, this concept may be reversed.

As yet another example, a device may wake at intervals to detect only an IR signal. The RF detector (or RF portion of a joint detector) may remain asleep until the IR signal is received. Receipt of the IR signal may cause the RF detector to wake. Insofar as powering an IR detector generally requires less power than powering an RF detector, waking only the IR detector in this manner during a sleep mode may conserve power for the device.

As still another option, one of the RF and IR detectors may be constantly powered-up while the other detector sleeps. It should be noted this same operation may be applied to a single detector capable of detecting both RF and IR signals; powering the detection capabilities in one frequency band may be suspended until a signal of the other frequency is detected.

For at least one embodiment, the device can be configured to be compatible with existing receiving devices used on appliances such as Hunter Douglas Corporation's POWERRISE and/or POWERGLIDE window coverings. The device can be configured to operate universally with various types of appliances. Dip switches, or the like, can be included in the device and used to specify which of any given number of appliances a given device is compatible. For example, when used in conjunction with window coverings manufactured by Hunter Douglas, the device can include a selection switch which, upon selection of the appropriate pins, configures the device for operation with DUETTE, SILHOUETTE, VIGNETTE, POWERGLIDE, POWERTILT and other types of window coverings. That is, desirably the device can be readily connected to those appliances already including an IR or RF receiving device.

In one embodiment, a four pin conductor can be used to facilitate the adaptability of the device to existing appliances. In other embodiments, two, six, eight and other pin conductors can be used Likewise, the device can be configured to fit within existing openings in appliances, such as those currently occupied by IR or RF receiving devices. Further, the device can be configured to be compatible with existing remote controls and/or with the scope of the various embodiments of remote controls described herein.

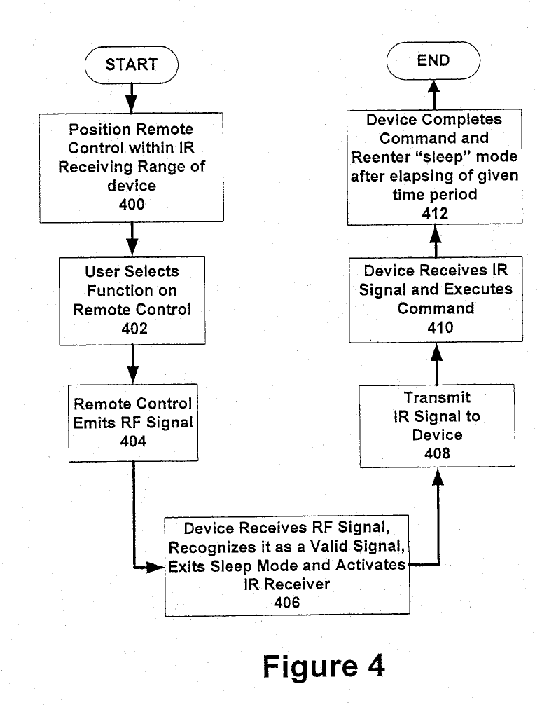

Referring now to FIG. 4a, a flow diagram depicting one implementation of an embodiment is shown whereby a single device can be controlled. The process by which a remote control 105 utilizes the IR and RF transmission mediums to communicate with a single device, such as device 110, starts for one embodiment with positioning the remote control 105 within the IR (and RF) receiving range of the device (Operation 400). The receiving range of a device for an IR and an RF signal will vary depending upon the wavelength of the communications signal utilized, the transmitting power of a remote control, the sensitivity of a device, and the surrounding environment. For example, RF signals commonly can be communicated through walls, but, IR signals require a direct line of sight between the transmitter and the receiver. Thus, it is to be appreciated that a user of a remote control provided in conformance with the embodiment can be positioned proximate to one more devices such that a direct line of sight connection can be established between the remote control's IR transmitter and a receiver on one or more devices.

Upon positioning the remote control 105 within the receiving range of the device 110 to be controlled, a user can select a function on the remote control 105 (Operation 402). For example, a remote control 105 can be configured such that a “down” button, when depressed, results in a command being communicated to a device that results in a window covering being lowered. Similarly, an “up volume” button might result in the volume of a audio system being increased.

Upon the selection of the function (which commonly occurs by a user depressing a button on the remote), the remote control 105 transmits an RF signal (Operation 404). As discussed above, the device commonly operates in a power-save mode, wherein the IR receiver in the device is in “sleep” mode (i.e., inactive) until a proper RF signal (i.e., one compatible with a predetermined signal and command protocol) is received. Upon receipt of a valid RF signal, the device exits sleep mode and activate its IR receiver (Operation 406).

After the transmission of the RF signal or simultaneously therewith, the remote transmits an IR signal to the device. Desirably, the device is within the line-of-sight of the remote at the time of transmission of the IR signal and the IR beam is directed toward the device (Operation 408). The IR signal may contain the command (e.g., tilt vanes up, or open vanes) for the device. The device receives the IR signal, verifies it has the proper signal protocols and, if so, executes the command (Operation 410).

Following transmission of the command, the remote continues to transmit at least the IR signal, and in many embodiments both signals, until the user releases a depressed button or a time-out condition occurs. Also, the remote can be programmed such that upon a user repeatedly depressing a button, or otherwise providing an instruction to the remote, the remote bypasses the transmission of the RF signal (with each button depression) and instead proceeds to continue transmitting the desire JR signal until the user stop depressing one or more buttons on the remote and/or a time-out condition occurs. Likewise, upon exiting “sleep” mode, a device can be configured so that it remains active for a given period of time and thereby is configured to sense a repetitious selection of a user interface component on a remote (Operation 412).

Further, it is to be appreciated that the remote can be configured to communicate commands, data and/or other information in the RF and/or IR signals it transmits to one or more devices. Further, exclusivity of commands between a remote control and any given device can be accomplished by embedding a device number or identifier in each command.

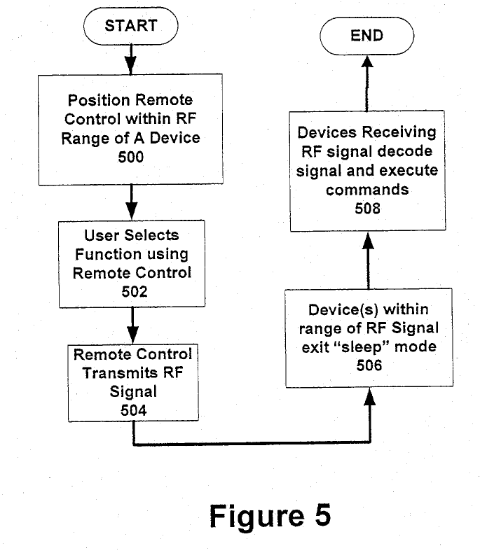

Referring now to FIG. 5, another embodiment of a method for using a dual media remote control device is shown. In this embodiment, the devices 110/120/130 are operated in a group mode, whereby each of the devices can be commonly controlled (for example, all of the devices are window coverings and the vanes therein are to be raised a given amount). This method proceeds with a user placing the RF remote within the range of one or more devices (Operation 500). For this embodiment, the RF signal and not an IR signal is transmitted. Thus, line of sight or point and shoot operations are not needed. The remote can be placed anywhere within the transmitting range of the remote and the receiving range of the device(s) to be controlled. In one embodiment, the remote transmits RF signals over a distance of 200 feet in a non-directional pattern.

Once the remote is positioned within the operating range of the devices, the process continues with the user selecting a function to be performed by depressing one of the pre-programmed group buttons (Operation 502). More specifically, in at least one embodiment, a remote is configured to include a plurality of “group” buttons. Each button, upon being depressed, places the remote 105 in a “group transmission” mode. When the remote is in a group transmission mode, any commands transmitted by the remote and carried on an RF signal containing a specific instruction and group identifier, such as “group 1, shades up” or “group 2, shades down” or the like (Operation 504). In other words, when a particular group is selected by pressing the corresponding group button on the remote, subsequent commands transmitted by the remote are executed only by devices belonging to the particular group in question. Correspondingly, devices are programmed, upon receipt, to exit “sleep” mode and process these received instructions (Operation 506). More specifically, for at least one embodiment, upon receipt of a group instruction from a remote, a device processes the instruction by determining which group is selected, whether the device has been previously programmed to be a member of the group and, if so, executes the instruction so that the desired result is achieved (e.g., the shades are closed, opened, tilted or the like) (Operation 508). Upon executing the received instructions, the device waits a predetermined time to determine whether any additional instructions are to be received and executed, and if not, returns to “sleep” mode.

Further, the instructions transmitted by the remote in the form of an IR signal can also and/or alternatively include information such as device identifiers, group identifiers, addresses or the like (collectively, “identifiers”). These identifiers can be associated with a group button (for example, one provided on a user interface) and transmitted in the IR signal such that upon receipt of the same, those devices receiving their designated device ID, group ID or the like will process any data and/or information communicated by the remote control in the IR signal. The transmitted data can include one or more commands for one or more devices to perform a given action or actions.

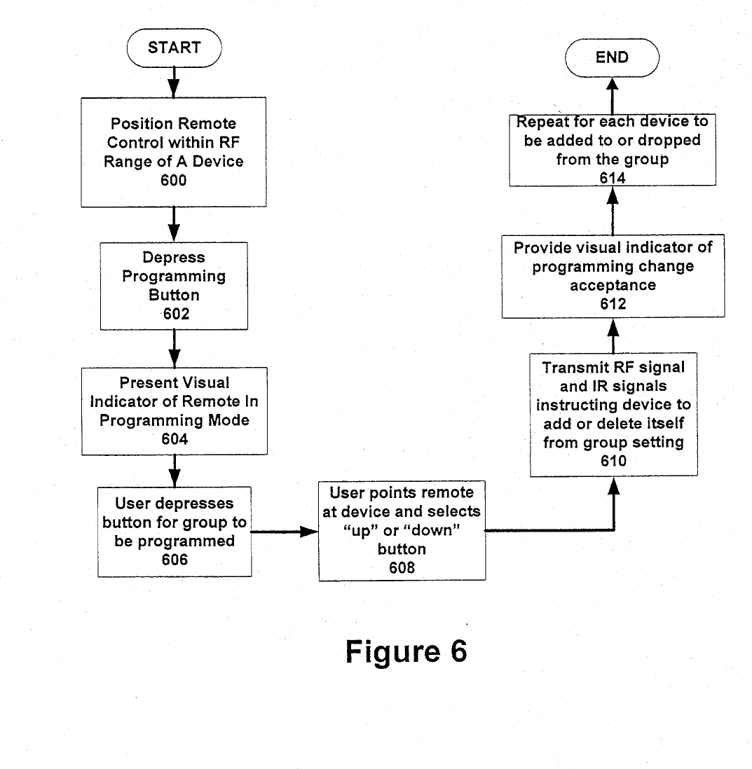

As mentioned above for at least one embodiment, devices can be programmed to belong to one or more groups. One embodiment of a process by which a device can be programmed is set forth in FIG. 6. This process begins with the positioning of the remote within the RF and IR range of the device (Operation 600). Next, a programming button is depressed, which upon activation places the remote into programming mode (Operation 602). At this instance, for at least one embodiment, a visual indicator on the remote is desirably illuminated and thereby signals the user that the remote is now in programming mode (Operation 604). Such indicator can be, for example, an LED. Other indicators, including auditory, tactile, visual, combinations thereof or otherwise can be used as desired to indicate to a user that the remote is in programming mode.

In certain embodiments, the device may not enter a programming mode until or unless both an RF and IR signal are received. Further, some embodiments may prevent the device from entering a programming mode until both an RF and IR signal are received within a certain time of each other (such as substantially simultaneously). In this manner, a remote control 105 having one wide beam pattern (e.g., an RF signal) and one narrow beam pattern (e.g., an IR signal) may be used to group only those devices within the range or dispersion area of the narrow beam pattern, thereby providing greater selectivity when grouping.

By combining IR and RF signals for grouping, the embodiments described herein may permit easily grouping multiple devices without the necessity of disabling the RF receivers of devices that are not desired within a group, or forcing a user to stand excessively close to devices desired to be added to a group, as may be required when using solely RF signals to group devices.

Returning to FIG. 6, programming continues with the user depressing the desired button to which group a device is to be added or dropped (Operation 606). The user then points the remote at the device to be added to the group and presses either the “up” button to add the device to the group or the “down” button to delete the device from the group (Operation 608).

As mentioned above, the user has desirably positioned the remote so that it is within the RF and IR ranges of the device. Upon selecting either the “up” or “down” button, the remote communicates an RF “programming” signal, which brings the device out of “sleep” mode and enters the device into programming mode, followed shortly thereafter by an IR programming signal which triggers the device to execute a programmed command transmitted via the RF signal. Following the RF program command and the IR signal instructing the device to enter programming mode, an RF signal is communicated by the remote to the device which instructs the device as to the group setting and its relation thereto (i.e., active or inactive with respect to the group setting). (Operation 610).

Thus, it is to be appreciated that in at least one embodiment, the programming of a device to respond to a group command includes the transmission of an RF signal to bring the device out of “sleep” mode, the transmission of an IR signal to individually select a device that is to be added or dropped from a group setting, and the transmission of a second RF signal that contains the commands and instructions necessary to program the device to respond to future received group commands. Alternatively, the commands and instructions can be provided in either the first RF signal and/or the JR signal, thereby negating any need to transmit the second RF signal.

Upon receiving the group programming commands, a visual indicator can be provided to the user. For example, in one embodiment the shade can be jittered (e.g., moved in short bursts in each direction) (Operation 612). One a device is programmed, the process can then repeated for each device that is to be added or deleted from a group (Operation 614).

Further, a remote desirably includes a plurality of group buttons. In one embodiment, four group buttons are provided. Additionally, an “all” button can be provided, as desired. In one embodiment, upon selection of the “all” button commands to all of the previously programmed groups are transmitted. For example, the selection of the “all” button followed by the “up” button would result in the remote sending the “up” command to all devices programmed to respond to groups 1-4 (when only four groups exist).

Alternatively, in other embodiments, the “all” button can be programmed using the same or similar programming steps discussed above with respect to FIG. 6. Further, other embodiments for configuring the “all” button can be used, such as, configuring all devices to respond to an “all” command.

Additionally, the remote and devices can each be configured to include a reset switch. Upon selection of the reset switch in a device group settings are desirably erased (in the devices). The reset button may be located on the remote control 105 in a position normally inaccessible during operation of the remote, such as beneath a battery cover. In this instance, pressing the reset button on the remote 105 will cause the remote's processor to synthesize a new address not recognized by the previously programmed devices.

Alternatively, the remote can be configured so that upon selection of the reset switch on a remote, the remote transmits a command signal to those devices within RF and/or IR signal range. The command signals instructs the devices receiving these signals to erase the stored group settings. As discussed above, the IR signal can be used to selectively control the resetting of devices and the RF signal can be used to efficiently communicate data and commands from the remote to the device(s).

Thus, it is to be appreciated that the foregoing systems and methods enable a user of a remote control to selectively command a device, when a plurality of devices are within the range and orientation of an IR or RF signal generated by a remote control. Further, the various embodiments described herein, as set forth above with respect to the described exemplary processes, enable a user to command a device without having to know the device's ID or other identifier in advance. Further, the foregoing processes enable a user to remotely command a device, using the before mentioned remote control, without having to depress a button, for example, on or connected to the device. It is to be appreciated that this feature can be extremely beneficial when, for example, a user desires to adjust just one of a plurality of closely spaced window coverings to which access to a device used to adjust a window covering is problematic or non-practical.

The various embodiments may also include a methodology by which group functions and similar functions can be programmed by a remote control with a corresponding device. In one embodiment, this programming includes the operations of configuring the remote in programming mode (for example, by selecting a programming button), pressing a desired group function button, and pointing the remote at the desired device while an IR signal is being transmitted. Desirably, these operations occur in conjunction with the device entering programming mode automatically or manually by, for example, depressing a programming button on the remote.

It should be noted that the foregoing embodiments, although described generally as transmitting and/or receiving IR and RF signals, could be configured to operate with signals broadcast at different frequencies or utilizing different energies. For example, instead of transmitting signals in the IR or RF ranges, a remote control 105 may transmit a signal to a device at a frequency generally corresponding to visible light (e.g., a laser). As yet another alternative, one or more signals described herein may be ultrasonic in nature instead of electromagnetic. Accordingly, it should be understood that the signals disclosed herein are meant as examples and not necessarily as limitations.

As described above, systems and methods are provided for using a remote control to identify and selectively control one or more devices, while conserving power in the device(s), by using an RF signal as a trigger to one or more devices to exit “sleep” mode, and an IR signal which triggers one or more devices to execute a command transmitted in the RF signal. Further, the system and method includes the use and providing of a remote and corresponding devices to control a plurality of devices simultaneously using RF generated group commands. Methods for programming devices to respond (or not respond) to group commands are also provided. Therefore, it is to be appreciated that certain various embodiments described herein utilize a dual media signal system to detect and control one or more devices, such as one or more window coverings. While the present invention has been described above with respect to various system and process embodiments, it is to be appreciated that the present invention is not so limited and includes those systems and methods that utilize dual media control as covered by the scope and breadth of the following claims.

1. A method for operating a device, comprising the operations of:
receiving a first communications signal having a first characteristic;
in response to the first communications signal, configuring a device into a first operative state;
receiving a second communications signal having a second characteristic, the second characteristic different than the first characteristic, and prior to receiving the first communications signal, the device is inoperative to receive the second signal;
determining at least one command provided in the second communications signal; and
executing the at least one command.

2. The method of claim 1, wherein:
the first communications signal is one of an infrared signal and a radio-frequency signal; and
the second communications signal is the other of the infrared signal and the radio-frequency signal.

3. (canceled)

4. The method of claim 1, further comprising:
in response to receiving the first communications signal, activating a receiver attuned to the characteristic of the second communications signal.

5. The method of claim 4, further comprising:
in the event the at least one command is a grouping command, determining if the first and second communications signals are received simultaneously;
if the first and second communications signals are received simultaneously, executing the grouping command; and
otherwise, ignoring the grouping command.

6. The method of claim 4, further comprising the operation of deactivating the receiver attuned to the frequency of the second communications signal after a set time from receipt of the second communications signal.

7. The method of claim 6, further comprising:
deactivating a first receiver operative to receive the first communications signal after a second set time from receipt of the first communications signal; and
periodically activating the first receiver after deactivating it.

8. The method of claim 1, wherein:
the first communications signal includes a first beam pattern; and
the second communications signal includes a second beam pattern different from the first beam pattern.

9. An apparatus for remotely controlling a device, comprising:
a first transmitter operative to transmit a first communications signal with a first characteristic;
a second transmitter operative to transmit a second communications signal with a second characteristic;
a processor operative to control the first and second transmitters;
a group command module operative to transmit a grouping command to the device via one of the first and second transmitters, the group command module controlled by the processor;
an operation command module operative to transmit an operation command to the device via one of the first and second transmitters, the operation command module controlled by the processor; and
a wake command module operative to transmit a wake command to the device via one of the first and second transmitters, the wake command module controlled by the processor.

10. The apparatus of claim 9, wherein the processor controls at least one of the group command module, operation command module, and wake command module in response to an input from a user interface operably connected to the processor.

11. The apparatus of claim 9, wherein the wake command is identical to at least one of the grouping command and operation command.

12. The apparatus of claim 9, wherein:
the first transmitter is a radio frequency transmitter; and
the second transmitter is an infrared transmitter.

13. The apparatus of claim 12, wherein the first and second transmitters may transmit simultaneously.

14. The apparatus of claim 13, wherein:
the radio frequency transmitter transmits the first communications signal at a first frequency corresponding to a radio frequency and further transmits a third communications signal at a third frequency;
the third frequency is likewise a radio frequency; and
the third frequency is different from the first frequency.

15. The apparatus of claim 14, wherein the first communications signal and third communications signal are transmitted substantially simultaneously.

16. A device operative to respond to a first and second remote signal, comprising:
a processor;
a first receiver operative to receive a first communications signal and convey first information associated with the first communications signal to the processor;
a second receiver operative to receive a second communications signal, but not prior to said first receiver receiving said first communication signal, and convey second information associated with the second communications signal to the processor; and
application circuitry operative to control at least a portion of the device in response to a command from the processor, the command based at least partially on one of the first information and second information.

17. The device of claim 16, wherein the device is a covering for an architectural opening.

18. The device of claim 17, wherein:
the first communications signal is an infrared signal; and
the second communications signal is a radio-frequency signal.

19. The device of claim 18, wherein:
one of the first information and second information includes a group identifier and an operating command;
the processor is operative to determine if the device belongs to a group corresponding to the group identifier; and
the processor is further operative to operate the application circuitry in accordance with the operating command in the event the device belongs to the group corresponding to the group identifier.

20. The device of claim 18, wherein the second receiver is inoperative until the first communications signal is received by the first receiver.

21. The device of claim 20, wherein the first receiver cycles periodically from a sleep state to a wake state.

22. The device of claim 18, wherein:
one of the first information and second information contains an instruction to place the device into a group;
the processor is operative to determine if the first communications signal and the second communications signal are received substantially simultaneously;
the processor is further operative to place the device into the group only if the first and second communications signals are received substantially simultaneously.

23. The device of claim 18, wherein:
one of the first information and second information contains an instruction to remove the device from a group;
the processor is operative to determine if the first communications signal and the second communications signal are received substantially simultaneously;
the processor is further operative to remove the device from the group only if the first and second communications signals are received substantially simultaneously.
